(19) United States
(12) Patent Application Publication
(10) Pub. No.: US 2013/0339246 A1
(43) Pub. Date: Dec. 19, 2013

(54) SECURITY SYSTEM

(71) Applicant: Glory Global Solutions (Holdings) Limited, Basingstoke (GB)

(72) Inventors: Olivier MARTIN, Auvernier (CH); Sebastian JEANBOURQUIN, Basingstoke (GB)

(21) Appl. No.: 13/918,057

(22) Filed: Jun. 14, 2013

(30) Foreign Application Priority Data
Jun. 15, 2012 (GB) GB1210707.4
Jun. 15, 2012 (GB) GB1210708.2
Jun. 18, 2012 (GB) GB1210797.5

(51) Int. Cl. G06Q 20/38

(52) U.S. Cl. CPC G06Q 20/3821
USPC 705/44

(57) ABSTRACT

An apparatus for processing documents and/or tokens of monetary value, operable locally or remotely via an application used on device. The apparatus has a record of a security certificate of the application, and a receiver which receives a request for an identification code from the device, the request being signed by the application used on the device. The receiver verifies the device as an approved device if the signed request is recognised based on the record of the security certificate. The apparatus generates an identification code, stores the identification code, and sends the identification code to the approved device. The apparatus is configured to receive a command from the application used on the approved device, which command utilises the identification code. The apparatus is further configured to compare the identification code utilised in the command with the stored identification code, and execute the command if they match.

This invention relates to security systems and particularly, but not exclusively, to a security system for a financial institution, including the premises and/or infrastructure of a bank and including the cash handling equipment, control systems, customer interfaces, staff interfaces, financial records and the connections there between. The invention further relates to the methods of operation,

In a known banking context, document and/or cash and/or token handling apparatus (referred to below as cash handling apparatus) can be used for customer facing transactions, bank internal cash management operations and be supervised and serviced from the Bank Head Office and Remote Service Locations for example a customer wishing to conduct a transaction such as withdraw cash from their account can do so via an authorised member of staff, such as a Teller, via a computer terminal. Upon instructions from the terminal, cash can be dispensed by the cash handling apparatus, from a secure cash box—located adjacent the Teller. For operation of cash handling apparatus a primary concern is their security. In known systems the cash handling apparatus is operable via a cable connected to the terminal. This kind of system is considered secure because the Teller, the terminal and the connection to the cash handling apparatus are all local to the workstation and located in secure bank premises and, therefore, a thief is inhibited from making a brute-force attack or a replay attack because accessibility is inhibited. In this context a brute-force attack is a known form of information-system (IS) attack that involves a miscreant bombarding a machine with messages in the hope of prompting a response. A replay attack is another IS attack that records a message sequence and replays it in the hope of recreating a previous activity.

Cash handling machines are known from applications such as WO2008/047094 and WO2010/108536. Further, it is known to connect a Teller interface with a document handling apparatus over a network. Known banking systems are limited in their functionality because communications between components over a network are susceptible to replay attacks.

It is against this background that the present invention has been made. The invention results from efforts to overcome the susceptibility of a system or apparatus to interference when operable over a connection, such as a network. Other aims of the invention will be apparent from the following description.

In one aspect the invention resides in an apparatus for process documents and/or tokens of monetary value, such as a teller cash recycler. The apparatus can be configured to process documents and/or tokens of monetary value. The apparatus is operable over a network via a device, such as a personal computer. The apparatus is operable by the device for commanding the apparatus to operate locally or remotely. The apparatus is operable by the device in at least one mode in which the apparatus was configured to operate. The apparatus can be operated to perform at least one of: detecting counterfeit cash; auditing cash; moving cash; dispensing cash; sorting cash; receiving cash; receiving cash and allocating funds to an account; providing a status report on the cash stored therein; receiving and installing updates to the firmware; amend the or each mode of the apparatus; and receiving and installing updates to the counterfeit detection system incorporated therein and/or diagnostics.

The apparatus has a receiver for receiving a request for an identification code (also referred to as a verification request) from a device. The verification request is received from a device that wants to command or control the apparatus to provide a service or execute a function, or change mode. The apparatus is configured to verify if the device is an approved device. If the device is recognised or approved, the apparatus generates an identification code, such a unique identification code (UID), and stores the identification code. Where the apparatus recognises the device as an approved device, then the apparatus, via a transmitter, communicator, or sender, sends the identification code to the device. A transmitter, or sender, in the context of the invention is part of the apparatus that can send an electronic signal across a network. Thereafter, the apparatus is configured to receive a command, or instruction, from the device. The command or instruction utilises the identification code and upon receipt the apparatus compares the identification code utilised with the command against the identification code stored in the apparatus. If the identification codes match then apparatus executes the command, or responds to the instruction. If the utilised identification code does not match the stored identification code then the apparatus will not execute the instruction from the device.

By way of example, the verification step within the apparatus, such as a cash handling machine, a typical example of which being a Teller Cash Recycler (TCR) leads to a UID being issued to a device such as a PC, which is running an application to interact with the TCR. The application uses the UID to establish a ‘session’ on the TCR. For the duration of the session the TCR is operable, via an application on the PC, to perform tasks. For example, a customer may request a withdrawal of currency of a requested value, and the PC will communicate with the TCR to check the availability of that amount of cash, by note denomination, and determine if there is enough cash to provide the sum requested. If available, the TCR will dispense the cash. Optionally, more actions may be undertaken during a single session. When the session is complete, the application will terminate the session. Additionally or alternatively, the TCR can end the session after a predetermined amount of time has passed. It should be understood that a TCR can support multiple parallel operating sessions with multiple devices.

The receiver in the apparatus can be further configured to receive a request for a pre-code, such as a challenge. The purpose of a challenge is to establish a means by which coded information can be exchanged between the apparatus and the device in order to verify the authenticity of the device. In this way, security is enhanced because an extra check is added to the actions required for a device to obtain an identification code that will allow the device to command the apparatus to execute a task or function.

The combination of pre-code and identification code work together to improve security to provide a more secure apparatus compared to an apparatus that only uses one of the pre-code or identification code. The two stages of authorisation, which work together to inhibit a replay attack e.g. listening to, and repeating on the network, an instruction to the TCR to fraudulently dispense cash.

The apparatus can be configured to recognise whether a pre-code or an identification code has been re-used. If the apparatus recognises a pre-code or an identification code then the apparatus will not respond to a device trying to command the apparatus or establish a communication, or communication session with the apparatus. In other words, the apparatus compares an identification code received from a device with those previously received. Previously received pre-codes and/or identification codes can be stored in the apparatus.

A request for a pre-code is started by a request from the device to a generator in the apparatus, for example, the application running on the PC. The generator can be further configured to generate a pre-code that includes information unique to the apparatus, store the pre-code and send the pre-code to the device.

Thereafter, a receiver in the apparatus can be configured to receive a verification request. If the verification is successful the apparatus stores an identification code, and also sends it to the device that had requested the challenge. Note that the request for an identification code utilises the pre-code, which associate the pre-code and the authentication code together. The apparatus can be configured to compare the stored pre-code with the utilised pre-code to confirm the device is same device that made the request before an identification code is provided to the device.

The generator can be configured to generate a new pre-code independently of the device, and send the device the most recently generated pre-code. The generator can be an integral component of the apparatus. In this way, the challenge can be refreshed at various intervals e.g. every 5 minutes.

It will be understood that additionally or alternatively, the function of generating the pre-code and/or the identification code can be provided by the device. In case that the authentication process is driven by the device the overall process is the mirror of the above but the intent and purpose is the same.

The request for a pre-code and/or a request for an identification code can be certified by the device, and the apparatus can be configured to recognise the device.

The generator can be configured to generate a new pre-code independently of the device, the pre-code generator configured to create a pre-code having: a first component including at least one of a timestamp, the apparatus serial number or a pseudo-random number; and/or a second component including a hash of the first component. The second component can further include an apparatus secret. The use of a time stamp, random number, apparatus secret and/or a hash function can enhance the security between the apparatus and the device.

The apparatus can be configured to execute a device command if the utilised identification code is used for the first time. In this way the use of the UID is limited to a single use. The single use may limit the UID to opening, for example, one session between the TCR and the PC. Another level of security can be provided by requiring a UID for each action the TCR takes e.g. a UID is required to determine how much cash is held with the TCR, and another UID is required to request cash to be dispensed.

The apparatus can be a document handling machine configured to dispense documents, such as bank notes, and the device can be a manually operable computer device, such as a teller interface in a bank, which uses an application or similar program to operate a PC.

The function of the apparatus and device is not limited to the examples above. In the description of the invention given above the function of the apparatus may be undertaken by the device and the function of the device can be undertaken by the apparatus. The function of the apparatus and the device respectively may be assigned temporarily or permanently.

The apparatus can be a computer having a database configured to record monetary value, such as a bank account, and the device can be one of a manually operable computer device, such as a teller interface in a bank, or a PC, or a document handling machine configured to receive documents, such as bank notes.

In this way, the invention can be applied to different components on a network. Each component that has a function to be accessed or operated can be commanded or instructed by another component. In the description herein, the component with a function to be accessed or operate is referred to as the apparatus and the instructing component is referred to as the device. The roles, however, can be reversed.

In another aspect, the invention resides in a security system for securing communication between components connected over a network, which may include a local area, a wide area, web interconnected or any other available type of network. By way of example, the network connects a device with an apparatus. The system has: an apparatus, such as a teller cash recycler, for processing documents and/or tokens of monetary value. The apparatus is connectable over a network to a device, such as a personal computer, which is configured to command the apparatus to operate in any of its possible modes.

The apparatus can comprise one or more functions, or modes, including at least one of detecting counterfeit cash, auditing cash, moving cash, dispensing cash, sorting cash, receiving cash, receiving cash and allocating funds to an account, providing a status report on the cash stored therein, receiving and installing updates to the firmware, receiving and installing updates to the counterfeit detection system incorporated therein and/or diagnostics.

The system has a device for commanding the apparatus to operate in any of its possible modes; and a network connection connecting the apparatus and the device, wherein the apparatus is configured to: receive a verification request yielding an identification code from the device, the apparatus configured to verify and check if the device is an approved device; generate an identification code, and store the identification code; send the identification code to the approved device; and receive a command from the approved device, which utilises the identification code, and compare the identification code utilised and execute the command if the utilised identification code matches the stored identification code.

The apparatus can be further configured to: receive a request for a pre-code from the device; generate a pre-code that includes information unique to the apparatus, store the pre-code and send the pre-code to the device; receive a request for an identification code from a device, wherein the request utilises the pre-code; and compare the stored pre-code with the utilised pre-code to confirm the device is the same device that made the request before an identification code is provided to the device.

The apparatus can be further configured to generate a new pre-code independently of the device, and send the device the most recently generated pre-code.

In yet another aspect, the invention resides in a method for securing communication over a network between an apparatus, such as a teller cash recycler, for processing documents and/or tokens of monetary value. The method can also modify the or each mode of operation associated with the apparatus. The apparatus is connectable over a network, which may include a local area, a wide area, web interconnected or any other available type of network, to a device, such as a personal computer, which is configured to command the apparatus to operate in any of its possible modes.

The apparatus can comprise one or more functions, or modes, including at least one of detecting counterfeit cash, auditing cash, moving cash, dispensing cash, sorting cash, receiving cash, receiving cash and allocating funds to an account, providing a status report on the cash stored therein, receiving and installing updates to the firmware, receiving and installing updates to the counterfeit detection system incorporated therein and/or diagnostics.

The method includes: receiving at the apparatus a verification request for an identification code from a device, and verifying if the device is an approved device; generating in the apparatus an identification code, and storing the identification code therein; sending the identification code to the approved device; and receiving a command from the approved device, which utilises the identification code, comparing the identification code utilised and executing the command if the utilised identification code matches the stored identification code.

The method can further include receiving at the apparatus a pre-code from a device; generating a pre-code that includes information unique to the apparatus, storing the pre-code and sending the pre-code to the device; receiving a request for an identification code from a device, wherein the request utilises the pre-code; and comparing in the apparatus the stored pre-code with the utilised pre-code to confirm the device is same device that made the request before providing an identification code to the device.

The method can further include generating a new pre-code independently of the device, and sending the device the most recently generated pre-code.

The method can further include executing the command on the condition that the utilised identification code is used for the first time.

In yet another aspect, the invention resides on a computer-readable medium having computer executable instructions configured to enable a computer to implement a method disclosed herein.

In light of the teaching herein, the skilled person would appreciate that like features or functions provided in one aspect of the invention can reside in another aspect.

The skilled person would also appreciate that the invention herein enables banking facilities to be securely connected over a network, thus inhibiting the opportunities for an attack via the network connecting the facilities, such as teller cash recyclers and Teller PCs, By having a component on the network, such as a TCR, means that the TCR can be shared amongst different Teller PCs. More flexibility can be provided in terms of relocation of equipment, maintenance of the equipment and updating the equipment. Maintenance and software (including firmware and template) updates can be carried out remotely; cash levels and general status can be monitored remotely etc. Further, the cost of providing and maintaining and servicing the components can be lowered because accessibility is improved and resources can be shared.

In order that the invention may be more readily understood, reference will now be made, by way of example, to the drawings in which:

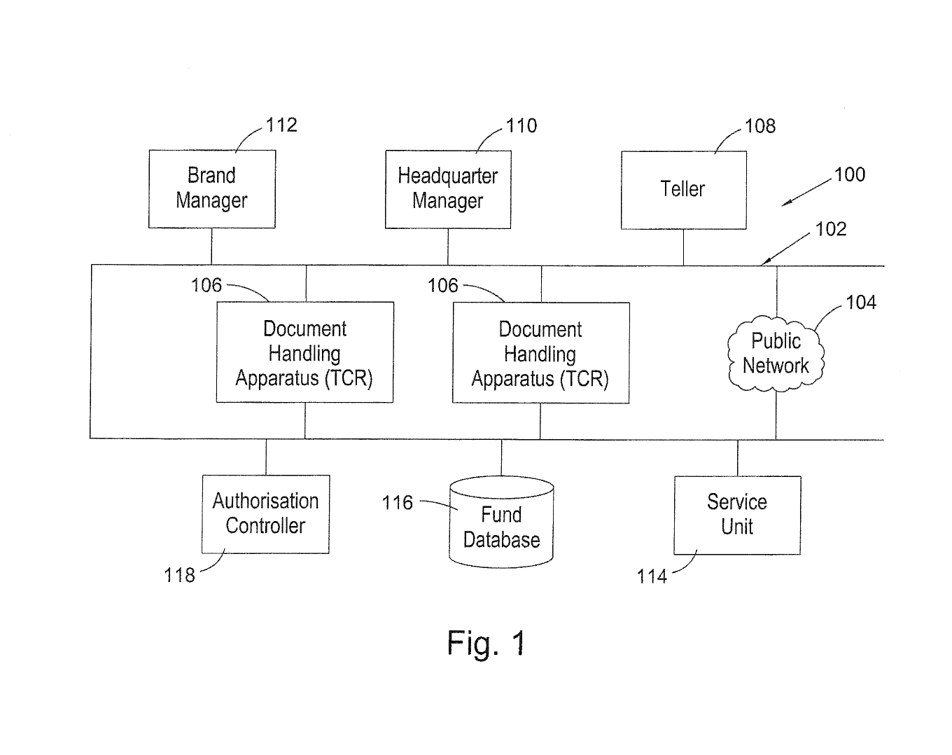

FIG. 1 is a block diagram of a system incorporating devices and apparatus that can communicate with each other over a network, said devices and apparatus, and communications there between, in accordance with an embodiment of the invention;

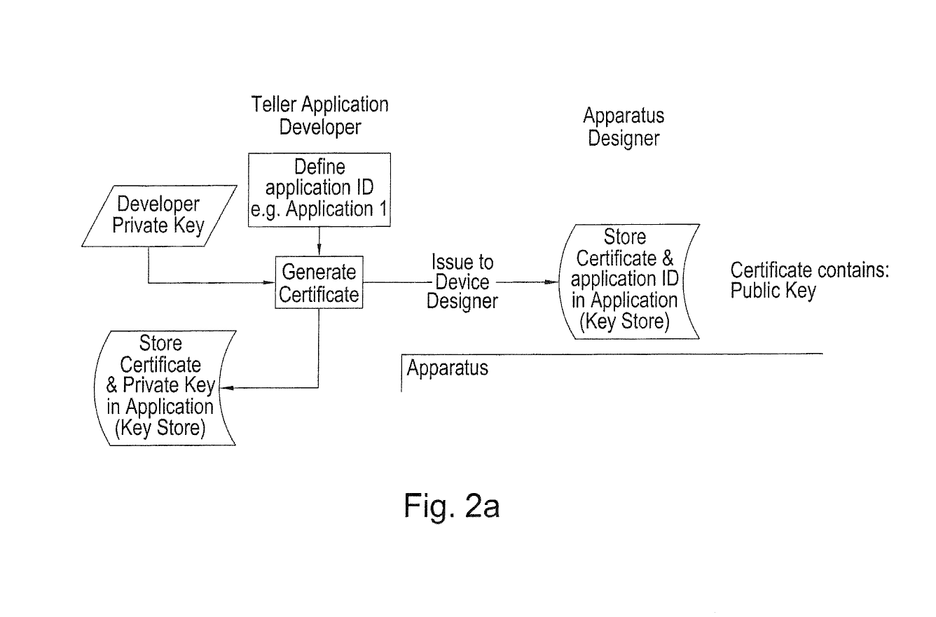

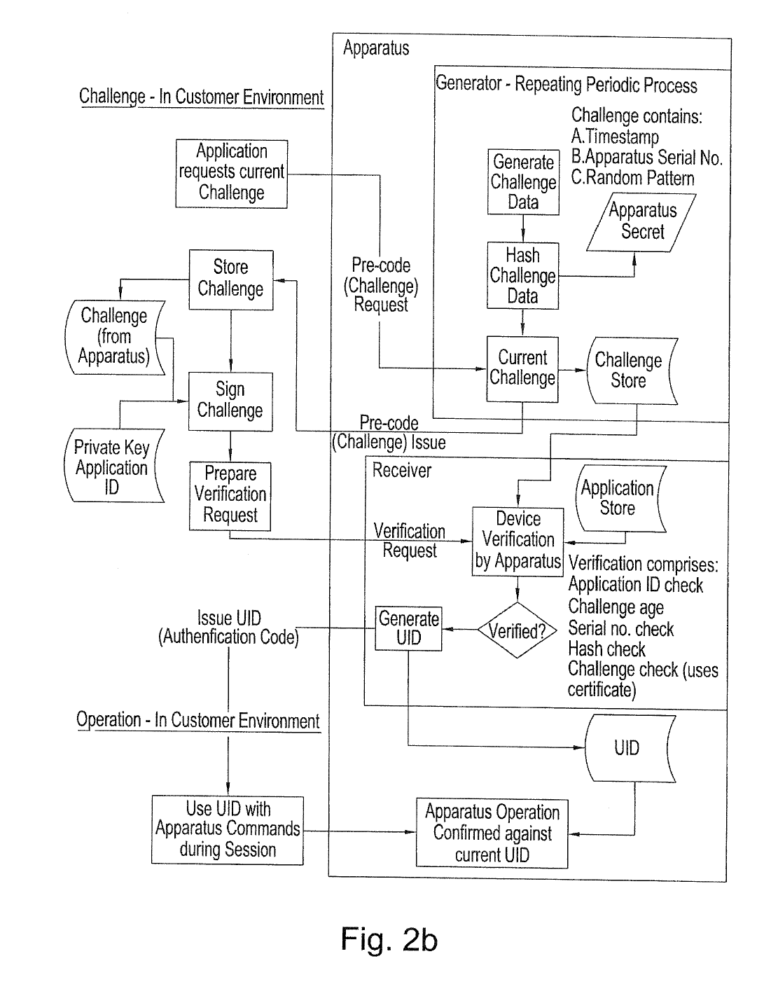

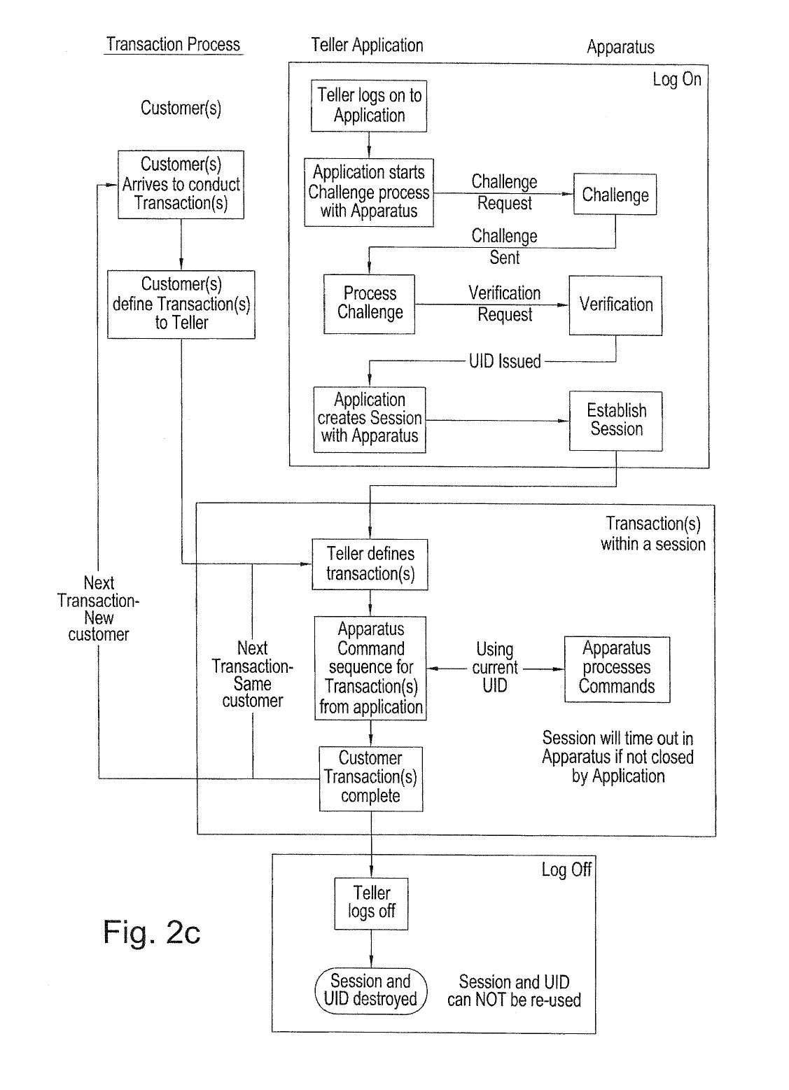

FIG. 2a is a flow chart outlining the generation and allocation of certificates;

FIG. 2b is flow-chart outlining communications between a device and an apparatus of FIG. 1 according to an embodiment of the invention;

FIG. 2c is a flow-chart outlining the relationship between a customer transaction, a Teller Application and a document handling machine; and

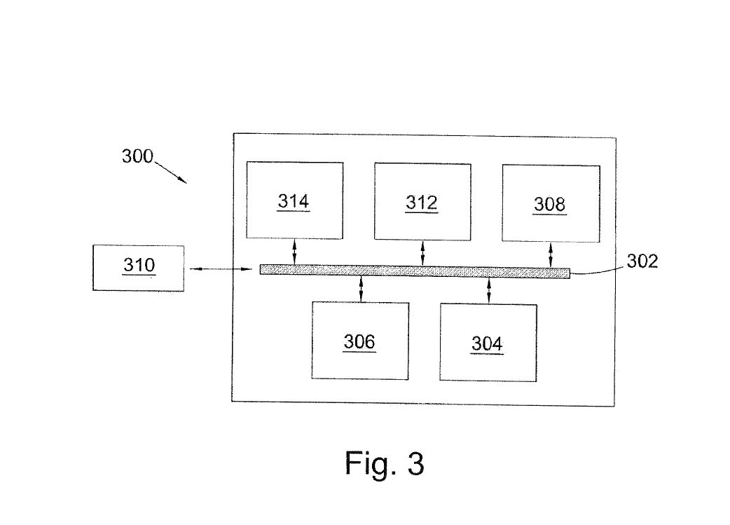

FIG. 3 is a system diagram of a component, such as a device or apparatus, according to the invention, such as a Teller's computer terminal.

FIG. 1 shows a system 100 of devices and apparatus connected via a network 102, including a public network 104. The system includes one or more document handling apparatus 106 and a computer terminal 108 that is, by way of example, operable by a member of the banking staff, such as a Teller to control the document handling apparatus. These elements of the system are known from, and described in WO2008/047094, which is incorporated herein by reference. By way of the example, the document handling apparatus 106 will be referred to as a TCR 106 and a computer terminal 108 will be referred to as a Teller 108.

The network 102 connects a number of components of a financial institution, including: a headquarter manager 110, typically remotely located from the other components in the head office of the financial institution that is operable to control and/or perform the function of the other components on the network, such as the TCR 106; a branch manager 112, typically located on the same premises as the TCR 106, and operable to have supervisory control over those components located on the premises of, for example, a bank; a service unit 114, which can be a portable device used by a service technician to maintain or assess the components connected to the network 102, or can be connected directly to the network, connected via a customer operated virtual private network (VPN), via a web portal, via a web server or other remote means ; a fund database 116, which records the status of a plurality of individual or business bank accounts, and is operable to modify the status of account details therein; and an authorisation, or key controller, 118 that generates the key, keys or certificates for providing means for encrypting communication between the or each component.

The term ‘key’ should be construed broadly in this specification. Conventionally, a key is mechanical device but in relation to the invention the key is an electronic or data constituted digital key, such as an encryption key.

The components shown in FIG. 1 have been described as components. A system 100 according to the invention, however, is not so limited and, by way of example, a single computer terminal in a bank office can incorporate the functionality of the Teller 108, branch manager 112 and the key controller 118. The multiple functions available via the network can be accessed via a single application upon the terminal 108, or via two or more devices. To be clear, and by of further example, a device such as a key controller 118, which can generate and distribute encryption keys and certificates, can be incorporated in one or more devices.

For security reasons, however, the key controller 118 application can be stored in a secure location, such as within the TCR 106 that holds money; the design offices of the software application developer; the design offices of the device designer; or in the head office controller 110, which typically connects to all bank offices, in order that the management of keys can be centrally controlled and managed i.e. cancellation and replacement of keys. The management of keys can be implemented over the network, or via a direct interface e.g. the service unit 114 connects via a USB cable directly to a TCR 106.

Public keys, private keys and certificates of a component of the system can be stored in the component itself. Public keys and certificates of one component can be provided to other components to enable components to communicate securely. The generation of keys can be carried out with a component by, for example, an application developer, or can be generated internally within a component. The invention improves the security between two devices over a private network 102 or a public network 104, and will be described, by way of example, using the document handling apparatus, TCR, 106 connected to a Teller 108 over a network 102, 104.

In this example, the TCR 108 is responsible for the ‘status’ or value of funds and issues cash in response to an authorised request. The Teller 108 is the interface used to change the status, and is a computer terminal running an application that enables an operator to request money to be dispensed from the TCR.

The invention, however, is not so limited and the role of the TCR 106 can be reversed if it is configured to receive and register a monetary deposit by communicating with a computer storing a database 116, such that the database records an increase in the value of a bank account. To be clear, the TCR 106 can receive instructions to dispense cash, thus debiting an account and/or can send instructions upon receiving cash, thus crediting an account. Both scenarios are susceptible to criminal acts.

Communicating devices can be provided with a public key, private key and certificate before communication takes place. Additionally or alternatively, the keys and/or certificate can be dynamically generated before, for example, each communication or request. A public key can be provided to a device in advance. Various configurations are possible in light of the teaching herein.

In broad terms, a Teller 108 is operable to request a cash withdrawal from a TCR 106 by sending a communication to the TCR within a session. As described above, an application operating on a Teller can use a UID to establish a ‘session’ on the TCR. For the duration of the session the TCR is operable, via an application on the PC, to perform tasks.

Before a session can be established, the Teller initiates a request for an identification code (UID) that enables the Teller to command the TCR to dispense cash. The TCR receives and analyses the request against predetermined criteria e.g. the Teller is an authorised device. If the request meets the criteria, the TCR provides the Teller with an identification code, which the Teller subsequently uses to command (the command utilising the identification code), the TCR to dispense cash. The TCR compares the identification code with the code received and only dispenses cash if i) the codes match and ii) the receipt of the identification code is the first use of the identification code for a given session e.g. the identification code has not been used in other sessions previously. Note that the TCR can be configured to store a history of sent and received codes and requests in a memory, such as read only memory (ROM).

More specifically, before an identification code is issued by the TCR, the TCR verifies the source of a command by determining the authority of the Teller. The TCR receives a request for a pre-code from a Teller, and the TCR responds by providing a pre-code that includes information unique to the apparatus, and stores the pre-code. To obtain an identification code, the Teller is required to issue a request that utilises the pre-code, and the TCR compares the stored pre-code with the utilised pre-code to confirm the device is same device that made the request before an identification code is provided to the device.

The ability of the Teller to command the TCR to dispense cash can require two stages of authorisation, which work together to prevent a replay attack e.g. listening to, and repeating on the network, an instruction to the TCR to fraudulently dispense cash. One stage requires a request for a pre-code, or challenge, and another stage requires using that challenge (e.g. sending a verification request) to obtain a unique identification code that must be used to enable a command. The identification code is a single-use code, and the TCR will not accept a command that utilises an identification code that has been used previously.

Note that the aforementioned example can be initiated, by providing in advance, a Teller Application certificate, Teller identification details and/or a Teller Application public key to the TCR.

It will be understood that encryption techniques, such as for example HTTPS, are relevant to secured communications but that in accordance with the known art of multi-layer communication systems such encryption takes place in a different layer to that embodied in the description above.

As described above, the ability of the Teller to command the TCR to dispense cash can require two stages of authorisation. One stage requires a request for a pre-code, or challenge, and another stage requires using that challenge to obtain a unique identification code that must be used to enable a command. As before, the identification code is a single-use code, and the TCR will not accept a command that utilises an identification code that has been used previously.

FIG. 2a shows that the development of a software application for use on a device of the type described above involves generating a security certificate using a private key of the application developer. A copy of the certificate is provided to the manufacturer of the apparatus that the application is configured to control or command. In this example, the certificate is provided to the document handling apparatus and stored therein. This enables the apparatus to recognise an application communicating with the apparatus if the apparatus has a record of the certificate. Similarly, an application private key and/or certificate are integrated with the application, such that a device, operable with the application, can store a copy of the application private key and certificate (which includes the application private key).

FIG. 2b outlines one aspect of the invention and communications between an apparatus (the TCR) and a device (the Teller). More specifically, the Teller 108 is operable to issue a command e.g. request a cash withdrawal from a TCR 106, by sending a communication to the TCR.

The process is initiated by the Teller, which sends a request for a challenge, or pre-code, to the TCR. The TCR generates a new pre-code either periodically, or in response to each new request from the Teller. The challenge includes, by way of example, a timestamp, the serial number of the TCR device, a pseudo-random number or a combination thereof. The challenge can also include a hash of the information provided in the challenge. The hash can also include a TCR secret, which can be a predetermined number, or can be a pseudo-random number. The TCR then stores the challenge, challenge hash and/or pseudo-random number before sending the challenge, or pre-code, to the Teller. The pre-code can include the TCR public key. The pre-code can be unique.

The Teller receives the challenge, stores it, and signs/certifies it with a Teller certificate. The signed challenge then forms an ‘verification request’, or a request for an identification code. The verification request includes the pre-code that incorporates at least one of a Teller identification, one or more elements of the challenge and the challenge hash. The request is certified by the Teller and the TCR is configured to recognise the certificate so that the TCR can authenticate the source of the request.

Upon receipt of the verification request for an identification code, the TCR compares the request and the elements therein, with the stored pre-code. The TCR checks, for example: whether the Teller is known and authorized to make requests; the time elapsed since the original challenge was made or whether other elements originally provided in the challenge match those included in the request of the public key of the TCR. Note that improved security can be achieved by comparing the stored hash, sent within the original challenge, with the hash sent as part of the request for the TCR public key.

If the TCR recognizes the request as authentic then it sends an identification code to the Teller. The Teller can then optionally create a session (see FIG. 2c) which supports multiple commands or send a command to change the status of the TCR e.g. dispense cash.

Note that the apparatus (TCR) can receive a command from a device (PC) in stages. An authentication code (UID) can be obtained to enable the PC to provide the TCR with a first part of a request to the TCR, which the TCR then deciphers and then stores. Following sending the first part of the request, the PC can send a second part of a request to the TCR, which the TCR deciphers and combines or concatenates with the first part to have a complete executable request.

In between the sending of the first part of a request and a second part of the request the PC can send a fresh request for a pre-code (challenge) such that the first and second parts of the request are sent using separate UIDs.

By comparing the first UID associated with the first part of the earlier request together with the second UID associated with the second part of the request the TCR the TCR can double-check that the command is not a replay attack.

FIG. 2c shows a process in which a Teller Application ‘logs on’, or requests to connect to an apparatus. This is typically in response to a customer wanting to make a transaction with their account to withdraw cash, or deposit funds to/from their account. A Teller initiating a log-on follows the process of FIG. 2b, which will be described again in relation to FIG. 2c.

A Teller logs on to an application on a personal computer, or equivalent device. Using the Teller Application, a session can be established by sending a challenge request (request for a pre-code) to the apparatus and receiving a challenge prepared by the apparatus. The Teller Application processes the challenge and sends a verification request (request for an identification code) to request a UID. Upon verification by the apparatus that the Teller Application is a secure device and the same device that issued the challenge request a UID is sent to the Teller Application. The UID is used by the Teller Application to establish a session with the apparatus.

Through a Teller, and the Teller Application, a customer can define what transactions are to take place with the apparatus. Note that the apparatus in this example is a document handling machine, such as a TCR but can additionally or alternatively be a remote terminal on which a database holds a customer accounts.

With each instruction or transaction from the Teller, the Teller uses a identification code, or UID, to issue commands to the TCR that the TCR subsequently processes. The TCR can respond to the same UID through a session, or a new UID can be generated to execute each individual command.

After each session is completed or closed (by logging off), or after a predetermined amount of time has passed since the session started, or after a period of inactivity the or each UID used to execute a command expires and the TCR will, thereafter, only respond to a new and unused UID. The session is terminated and the UM cannot be reused.

FIG. 3 is a system diagram of a component of the invention, such as a Teller or TCR, upon which the method described herein can be implemented using, at least in part, software operating or an application operating on a computer system. By way of example, the Teller can comprise the components in FIG. 3, which is an example of a computer system 300. The computer system 300 includes a bus 302, at least one processor 304, at least one communication port 306, a main memory 308, a removable storage media 310, a read only memory 312 and a random access memory 314. The components of system 300 can be configured across two or more devices, or the components can reside in a single device.

The processor 304 can be any such device such as an Intel® or AMD® processor. The port 306 can be an RS-232 connection, or a Bluetooth connection. The port can be configured to communicate on a network such a Local Area Network (LAN), Wide Area Network (WAN), or any network to which the system 300 connects. The read only memory 312 can store instructions for the processor 304,

The bus 302 communicably couples the processor 304 with the other memory 310, 312, 314, 308 and port 306. The bus can be a PCI/PCI-X or SCSI based system bus depending on the storage devices used, for example. The removable storage 310 can be any kind of external hard-drives, floppy drives, flash drives, for example. The system and components therein is provided by way of example and does not limit the scope of the invention.

The processor 304 can implement the methods described above. In particular, the processor 304 can encrypt and/or decipher communications, such as requests or challenges.

The bus 302 can connect to the device to the network 102 or Internet 104. Additionally or alternatively, the processor 304 accesses the network via the port 306.

The present invention has been described above purely by way of example, and modifications can be made within the spirit and scope of the invention, which extends to equivalents of the features described and combinations of one or more features described herein.

The invention also resides in any individual features described or implicit herein or shown or implicit in the drawings or any combination of any such features or any generalisation of any such features or combination. In view of these and other variants of the invention, reference should be made to the accompanying claims in determining the scope of the invention.

1. An apparatus configured to process documents and/or tokens of monetary value, the apparatus operable locally or remotely over a network via a device, an application being used on the device for commanding the apparatus to operate in at least one mode in which the apparatus was configured to operate, and the apparatus having:
a record of a security certificate of the application used on the device;
a receiver for receiving a request for an identification code from the device, the request being signed by the application used on the device and the receiver being configured to verify the device as an approved device if the signed request is recognised based on the record of the security certificate;
a generator for generating an identification code, and a store for storing the identification code; and
a sender for sending the identification code to the approved device;
wherein the apparatus is configured to receive a command from the application used on the approved device, which utilises the identification code, and compare the identification code utilised and execute the command if the utilised identification code matches the stored identification code.

2. The apparatus of claim 1, wherein:
the receiver is further configured to receive a request for a pre-code from a device;
the generator is further configured to generate a pre-code that includes information unique to the apparatus, store the pre-code and send the pre-code device;
the receiver is configured to receive the request for an identification code from the device, wherein the request utilises the pre-code, wherein the apparatus is configured to compare the stored pre-code with the utilised pre-code to confirm the device is the same device that made the request before an identification code is provided to the device.

3. The apparatus of claim 2, wherein the generator is configured to generate a new pre-code independently of the device, and send the device the most recently generated pre-code.

4. The apparatus of claim 3, wherein the generator is configured to generate a new pre-code independently of the device, the pre-code generator configured to create a pre-code having:
a first component including at least one of a timestamp, the apparatus serial number of a pseudo-random number; and/or
a second component including a hash of the first component.

5. The apparatus of claim 4, wherein the second component further includes an apparatus secret.

6. The apparatus according to claim 1, wherein the apparatus compares an identification code received from a device with those previously received.

7. The apparatus according to claim 1, wherein the apparatus is a document handling machine configured to dispense documents, such as bank notes, and the device is a manually operable computer device, such as a teller interface in a bank.

8. The apparatus according to claim 1, wherein the apparatus is computer having a database configured to record monetary value, such as a bank account, and the device is one of a manually operable computer device, such as a teller interface in a bank, or a document handling machine configured to receive documents, such as bank notes.

9. A security system for securing information over a network, system having:
an apparatus for dispensing documents and/or tokens of monetary value;
a device using an application for commanding the apparatus to dispense a document and/or a token; and
a network connection connecting the apparatus and the device, wherein the apparatus is configured to:
store a security certificate of the application used on the device;
receive a request for an identification code from the device, the request being signed by the application used on the device and the apparatus being configured to verify the device as an approved device if the signed request is recognised based on the security certificate;
generate an identification code, and store the identification code;
send the identification code to the approved device; and
receive a command from the application used on the approved device, which utilises the identification code, and compare the identification code utilised and execute the command if the utilised identification code matches the stored identification code.

10. The system of claim 9, wherein the apparatus is further configured to:
receive a request for a pre-code from the device;
generate a pre-code that includes information unique to the apparatus, store the pre-code and send the pre-code to the device;
receive the request for an identification code from the device, wherein the request utilises the pre-code; and
compare the stored pre-code with the utilised pre-code to confirm the device is the same device that made the request before an identification code is provided to the device.

11. The system of claim 10, wherein the apparatus is further configured to generate a new pre-code independently of the device, and send the device the most recently generated pre-code.

12. The system of claim 11, wherein the apparatus is configured to generate a new pre-code independently of the device, the pre-code having:
a first component including at least one of a timestamp, the apparatus serial number or a pseudo-random number; and/or
a second component including a hash of the first component.

13. The system of claim 12, wherein the second component further includes an apparatus secret.

14. The system according to claim 9, wherein the apparatus is a document handling machine configured to dispense documents, such as bank notes, and the device is a manually operable computer device, such as a teller interface in a bank.

15. The system according to claim 9, wherein the apparatus is computer having a database configured to record monetary value, such as a bank account, and the device is one of a manually operable computer device, such as a teller interface in a bank, or a document handling machine configured to receive documents, such as bank notes.

16. A method for securing communication over a network between an apparatus for dispensing documents and/or tokens of monetary value, the apparatus connectable over a network to a device using an application for commanding the apparatus to dispense a document and/or a token, the method including:
storing a security certificate of said application at the apparatus;
receiving at the apparatus a request for an identification code from the device, the request being signed by the application used on the device, and
verifying the device as an approved device if the signed request is recognised based on the security certificate stored at the apparatus;
generating in the apparatus an identification code, and storing the identification code therein;
sending the identification code to the approved device; and
receiving a command from the application used on the approved device, which utilises the identification code, comparing the identification code utilised and executing the command if the utilised identification code matches the stored identification code.

17. The method of claim 16, wherein the method further includes receiving at the apparatus a pre-code from the device:
generating a pre-code that includes information unique to the apparatus, storing the pre-code and sending the pre-code to the device;
receiving the request for an identification code from the device, wherein the request utilises the pre-code; and
comparing in the apparatus the stored pre-code with the utilised pre-code to confirm the device is same device that made the request before providing an identification code to the device.

18. The method of claim 17, wherein the method further includes generating a new pre-code independently of the device, and sending the device the most recently generated pre-code.

19. The method of claim 16, wherein the method further includes executing the command on the condition that the utilised identification code is used for the first time.

20. A computer-readable medium having computer executable instructions for securing communication over a network between an apparatus for dispensing documents and/or tokens of monetary value, the apparatus connectable over a network to a device using an application for commanding the apparatus to dispense a document and/or a token; the computer executable instructions being configured to enable a computer to implement operations of:
storing a security certificate of said application at the apparatus;
receiving at the apparatus a request for an identification code from the device, the request being signed by the application used on the device, and
verifying the device as an approved device if the signed request is recognised based on the security certificate stored at the apparatus;
generating in the apparatus an identification code, and storing the identification code therein;
sending the identification code to the approved device; and
receiving a command from the application used on the approved device, which utilises the identification code, comparing the identification code utilised and executing the command if the utilised identification code matches the stored identification code.
